(19) United States
(12) Patent Application Publication
(10) Pub. No.: US 2019/0277190 A1
(43) Pub. Date: Sep. 12, 2019

(54) ULTRALIGHT FOUR-STROKE INTERNAL COMBUSTION ENGINE FOR RACING PURPOSES

(71) Applicants: Gábor CZIRA, Budapest (HU); Dora MOKRI, Vasarosnameny (HU); Andras GROSZ, Szeged (HU); Gez MAKAY, Szeged (HU)

(72) Inventors: Gábor CZIRA, Budapest (HU); Dora MOKRI, Vasarosnameny (HU); Andras GROSZ, Szeged (HU); Gez MAKAY, Szeged (HU)

(21) Appl. No.: 15/778,523

(22) PCT Filed: Nov. 23, 2015
(86) PCT No.: PCT/HU2015/000075

§ 371 Date: May 23, 2018

(51) Int. Cl. F02B 75/32; F02B 75/22; F02B 75/24

(52) U.S. Cl. CPC F02B 75/32; F16J 1/14; F02B 75/24; F02B 75/22

(57) ABSTRACT

“The present invention discloses a special arrangement of internal components in a machine. The boxer crankshaft installation comprises a special geometry to a 180° V-engine. The engine is designed by special geometry of connecting rod, characterized in that horizontal section of two back to Back U-shaped profile in reverse direction, which are connected to the central panel. Moreover, compact bolt are inserted for eliminating the harmful forces that cause opening of the bolt head, thereby at tightening distorting flexible the torsion torque is transmitted. The head consists of five separate radial plates, which connected by a ring-like mantle. The camshaft is characterized in with the larger diameter. There is an oil hole on the base circle and it is lubricating oil coat to the surface of the tappet. A special plate of a spring is characterized in that it is made of low density, high strength material.”

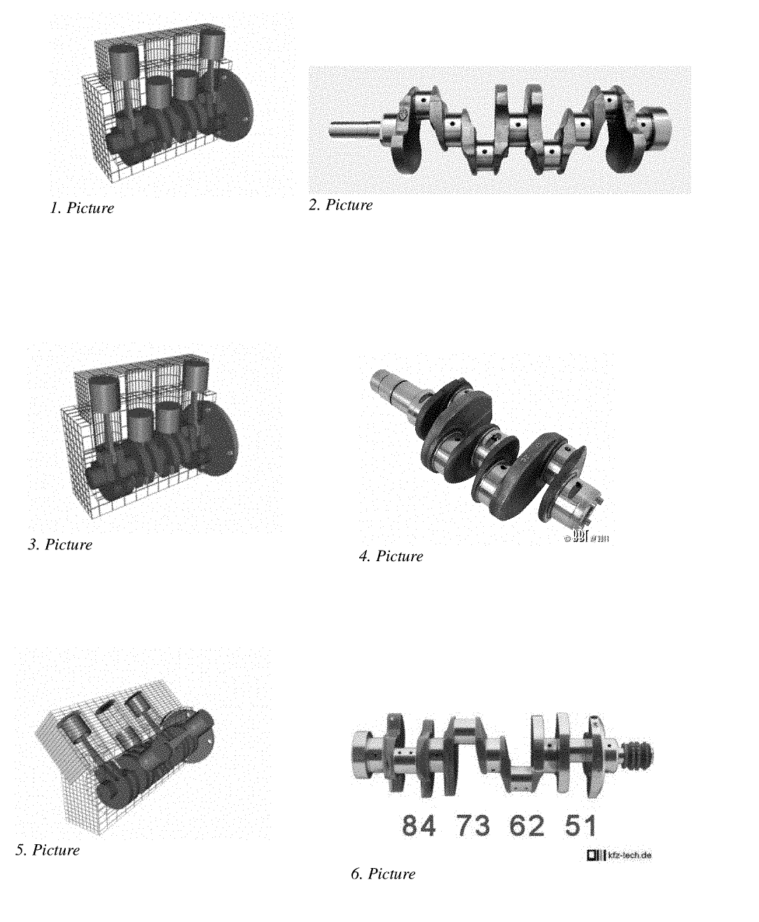

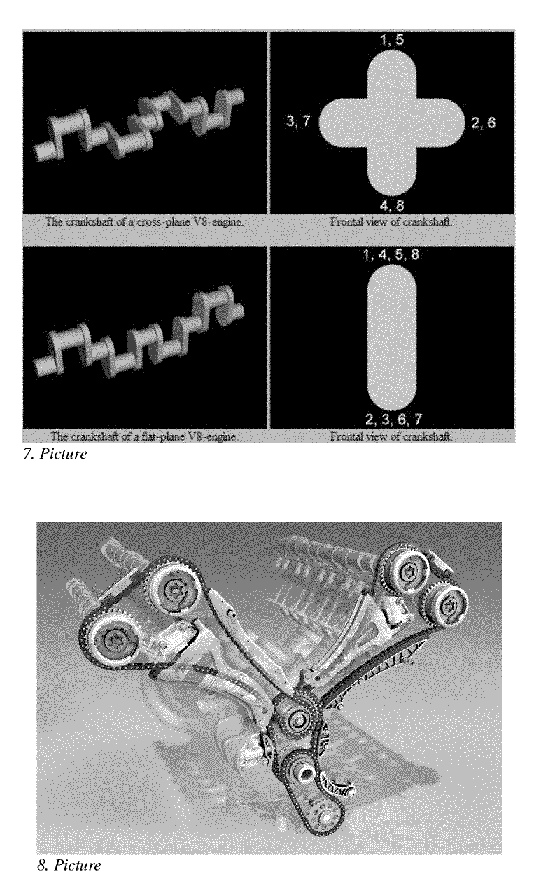

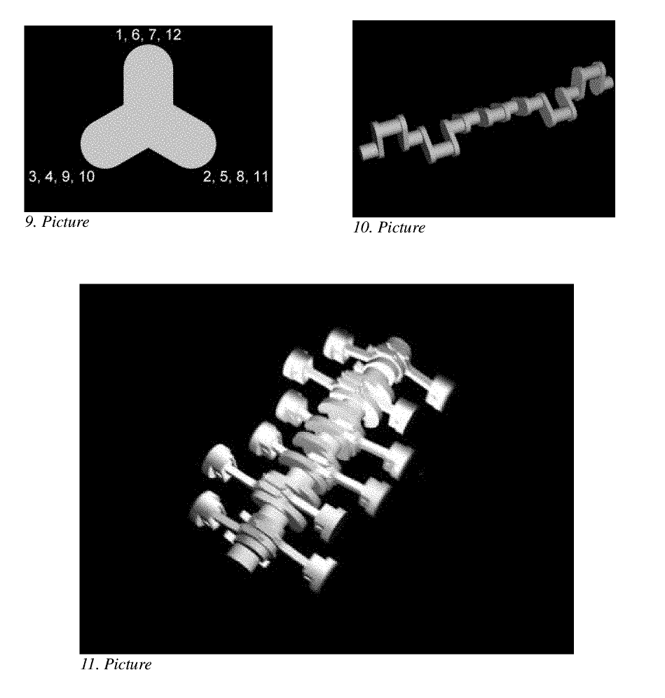

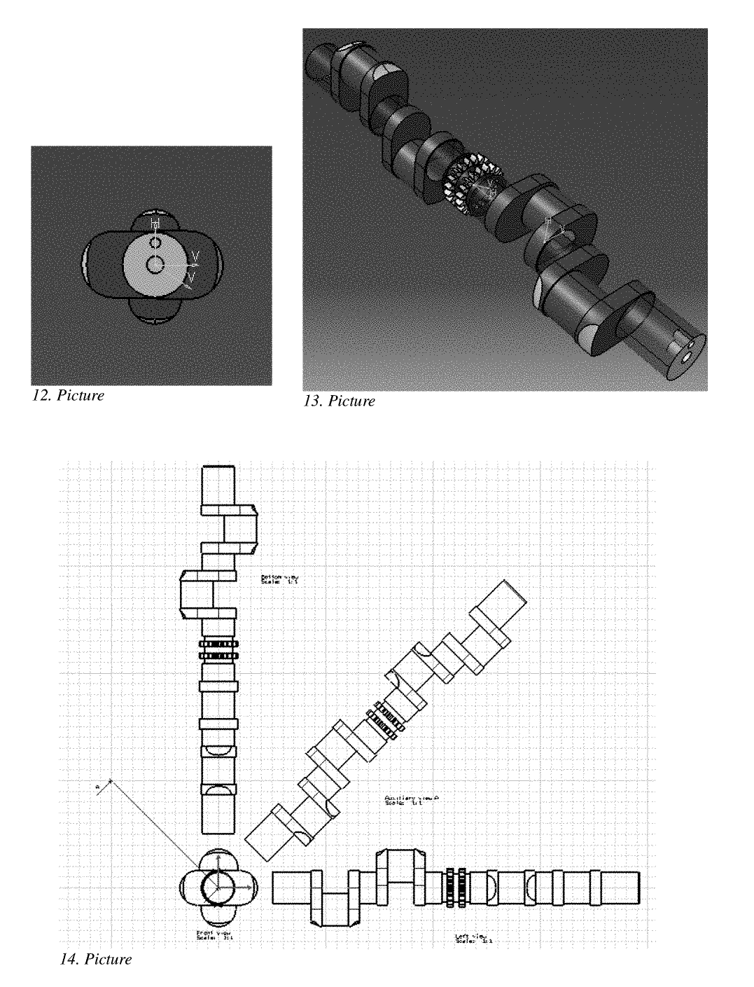

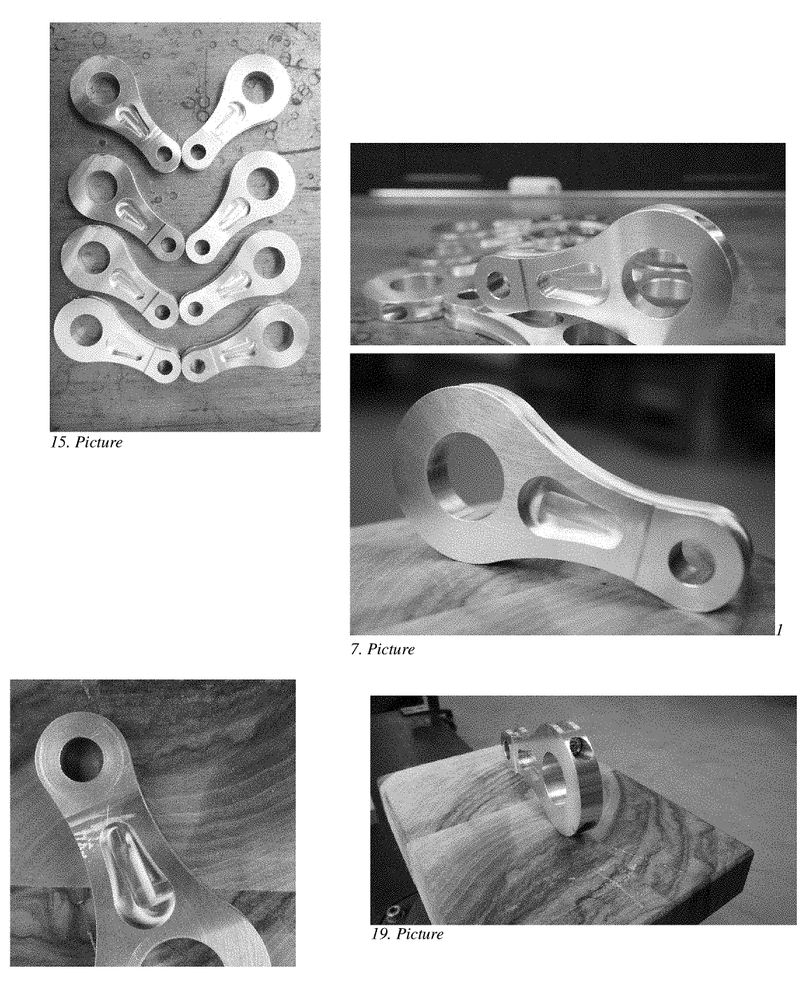

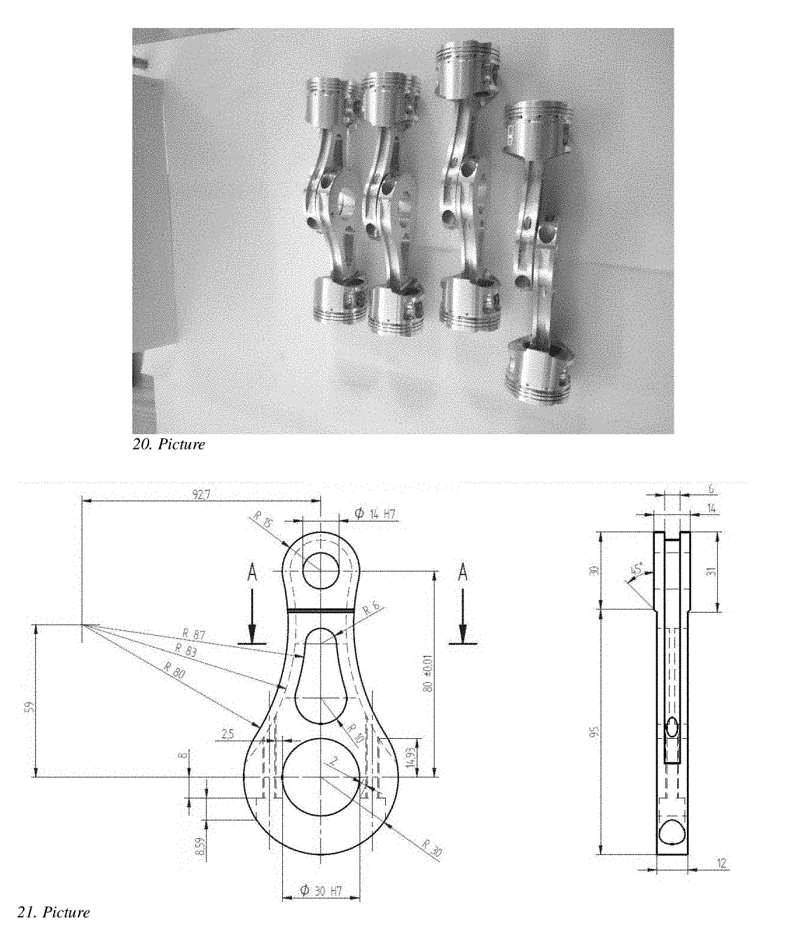

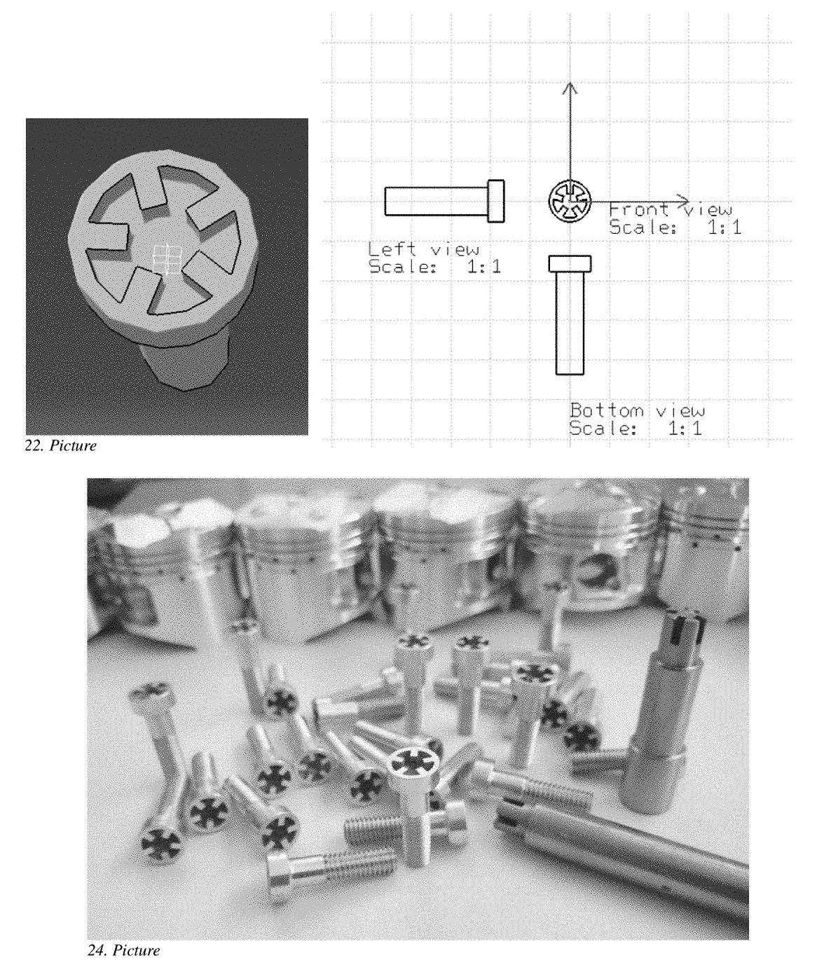

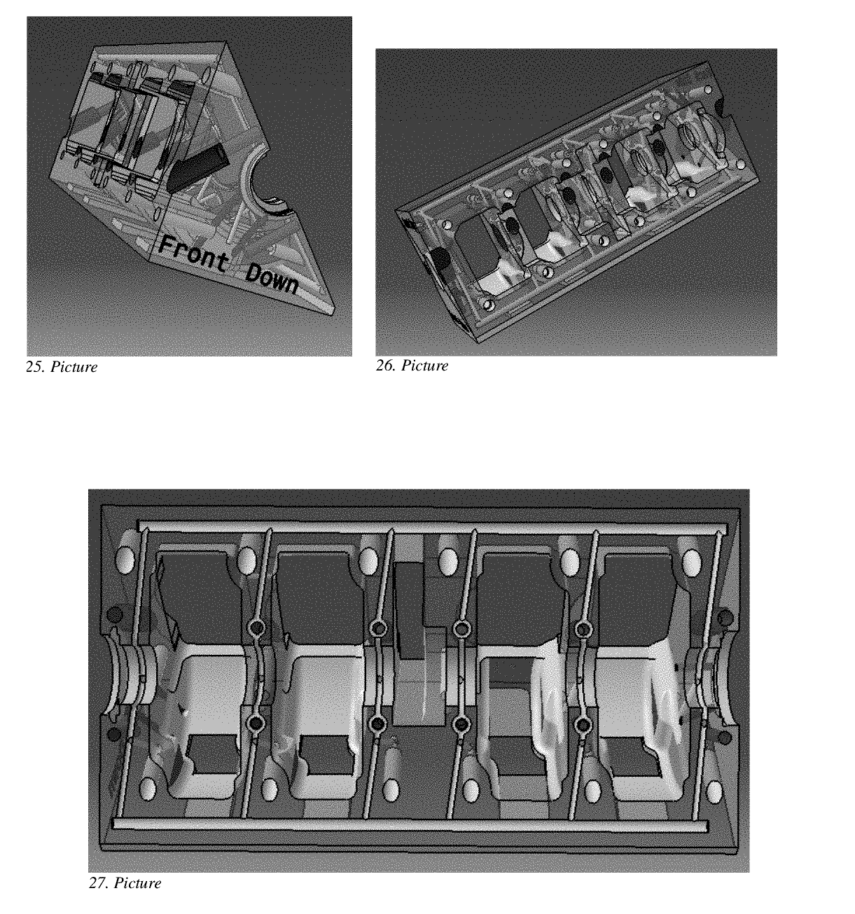

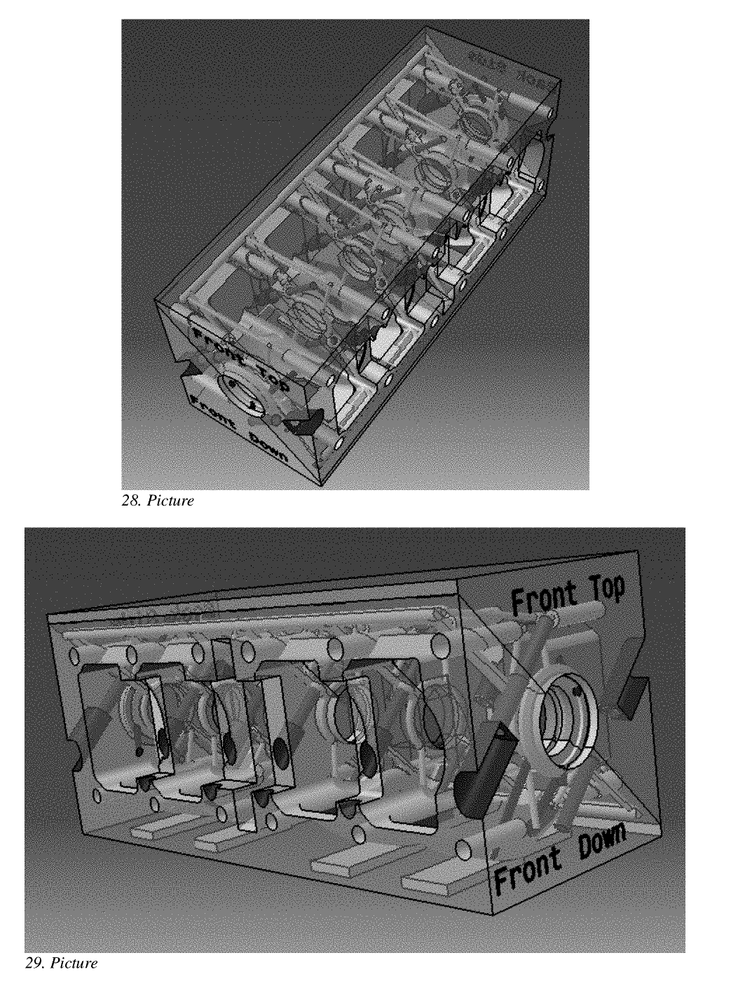

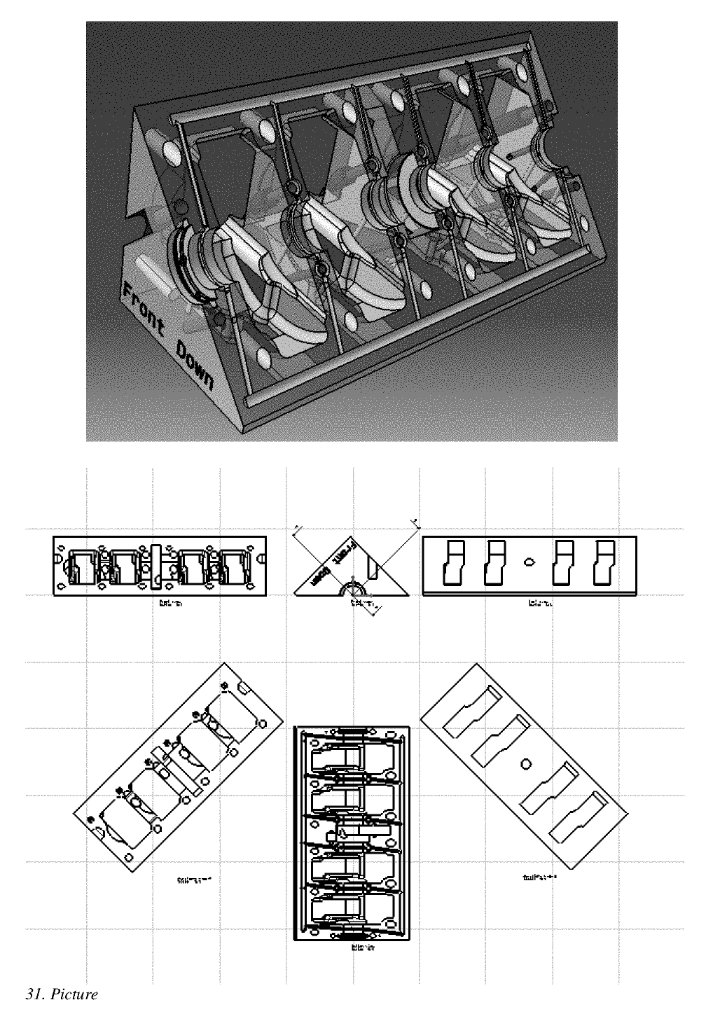

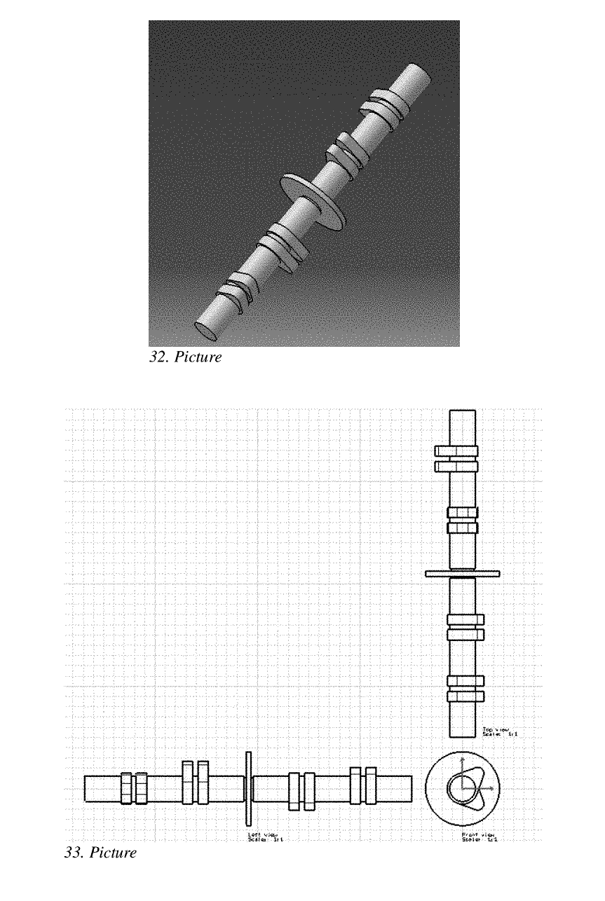

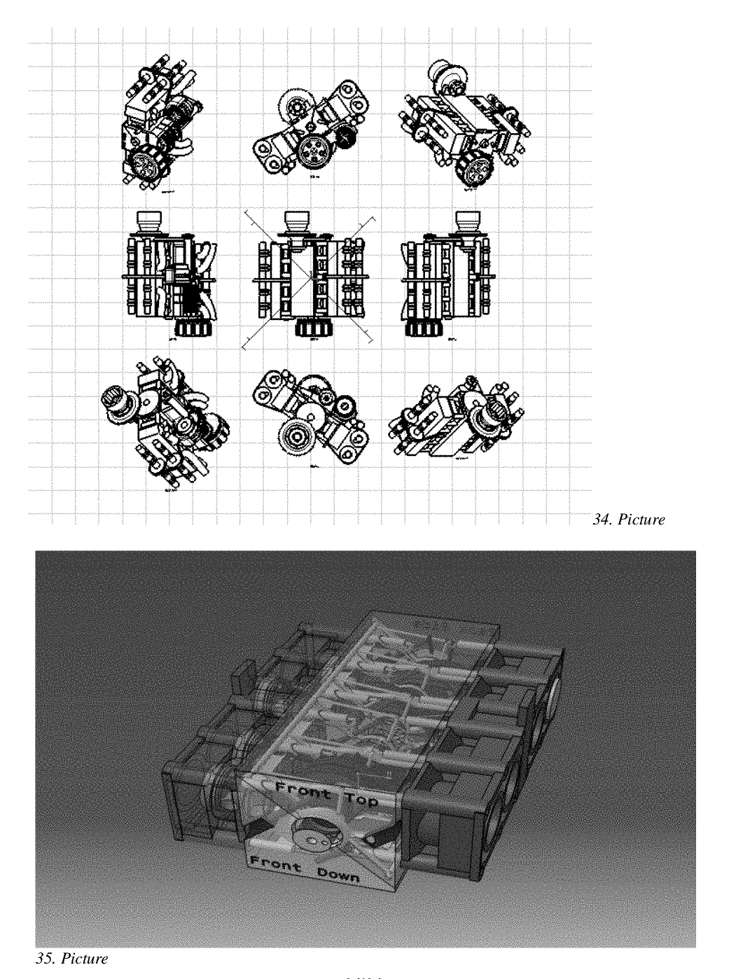

The engine is made for race car, so the compact and simple building strategy, low weight and low center of gravity is essential. In addition, the specific solution used within the engine offers a lot of new opportunities for the automotive industry.

With today's internal combustion engines' fundamental problem is balancing the pendulum. Up to now the only one complete solution of this problem is the boxer engine construction. The boxer engine biggest disadvantage is the heavy weight and a lot space requirement. For some other engines to solve the pendulum mass problem the engineers apply balance shaft, but it means plus dead weight for the engine. According to the building method what we innovated our engine needs less space than a boxer engine because we use a second connection rod on one crankshaft journal. With the pistons that belong to the second connection rod this construction become more compact and it remains absolutely balanced, because this solution take our construction similar to a 180° V engine that is built on a boxer crankshaft. From this point of view the main problem of the 180° V-engine is come from the crankshaft geometry, that cause the position of the connection rod journals typically not 180° and/or they so far away from each other so the forces couldn't be in one line. So the crankshaft of a V-engine need dead weight balance to neutralize the forces.

The goal of our engine is decrease the weight of the racing car and simultaneously increase the power. Our concept is based on that the smaller engine has got significantly less weight also, so the weight of the complete vehicle is decrease, consequently, fuel consumption is also more favorable.

In the racing life the low center of gravity is extremely important, because the vehicle in the corner effect to the centripetal force begin a lateral tilt and as a result rollover may occur. To avoid this, the parts must be designed to the center of gravity should preferably be lower. This problem has been eliminate the Boxer engine was the best solution, which cause the former mentioned disadvantages. (Picture 34)

### ENGINE CONFIGURATIONS

Inline Engine

The cylinders of these engines align in one row, so the axis that symbolized the cylinder-centers line in one plane. The pistons move almost in a vertical way. The connection rods belonging to each cylinders have own crankshaft conrod journals. The number of the crankshaft main journals is the number of cylinders+1 except for a few cases. This symbolic illustration shows the geometry of a four cylindered inline engine.

The disadvantage of this configuration is the large height, it coupled with high center of gravity with an overhead camshaft construction. (Picture 1; 2)

Boxer Engine

The cylinders are in a horizontal position in a boxer engine. They align in opposite pairs. In this way the pairs of cylinders move opposite each other. So if one of the pair is at top dead center, the other is in the same position on the other side of the crankshaft. Such as the inline engines every cylinder has own connection rod journal, so one connection rod connects to one rod journal. The boxer nature means that the angle of these rod journals is 180°. The advantage of the boxer engine is the integration height. The center of gravity can be lower and it has beneficial effect for driving dynamics.

The disadvantage of the boxer conception is that the integration space and the length of the engine are large because of the separately conrod journals. (Picture 3; 4)

V-Engine

The V-engine is essentially two inline engine with common crankshaft, the angle of two inline engine can be optional. The connection rods of the opposite cylinders align on the same conrod journal. The bearing is the similar to the four cylindered inline configuration, the difference is the double-length conrod journal. The advantage of this configuration is the short integration length. (Picture 5; 6; 7; 8) The 180° V-engines have traditional connection rod geometry. For example: 180° V12-engine connection rod angle is 120°. (Picture 9; 10; 11)

The Disadvantage is the Relative Large Height and Width and it Coupled with High Center of Gravity.

### The Properties of the Special Engine Conception

Crankshaft

The arrangement is another than V-engine, position of the journals is similar to boxer engines, because the angle of connection rod journal is 180° by segments (four cylinder), but two connection rod align on one connection rod journal. Due to the position of the journal and the proximity the counterweight is unnecessary. The pendulum and rotary (first and second) mass move the way to compensate each other.

The further advantage of this solution is the ignition for every 90° (crankshaft) angle. (8 cylindered construction). (Picture 35)

This balanced crankshaft is made of a special alloy, it's AW-7075 T6 and causes a significant weight losing. The 603 ccm engine's crankshaft is 1.2 kg. In order to further weight lose, the bearing is replaced with a thin film coating. (High wear resistance.) The coat is a thick elox layer or other material (ceramics, corundum) with sintering technology. (Picture 12-14)

Connection Rod

The concept requires that the geometry of the connection rod is designed to the collected oil by a piston—followed the piston move to the crankshaft—do not reach the opposed piston (higher RPM can be philharmonic) and it's possible to the slamming oil cause damage upon impact against the opposed piston.

Through the geometry the connection rod must be narrow and big extension for perpendicular to the crankshaft axis. This is compensated in the choice of materials is worth an unusual alternative material to choose, which in this case is a high-strength aluminum alloy: AW-7075 T6. In our case, the connection rod's material fulfills the requirements for the bearings, so the bearing can leave, that means less parts. (Picture 15-21)

Space-saving focusing on aspects the exact fitting is assured with a fitting fork at the assembling of the connection rod.

Special Pentagonal Bolt

The motorsport requires using of the lighter moving parts. Thus, the fasteners that hold the rod cups are also made of alternative materials. The material of the bolt that developed by us is the same of the connection rod: AW-7075 T6. A further advantage of the special bolt is its head design, which at tightening or opening the bolt forces acting perpendicular to the radius of the head. So eliminating the harmful forces that cause opening of the bolt head, thereby at tightening distorting flexible the torsion torque is transmitted. For example hex and torx, where the force for sides is caused to open the head; hexagon head, what causing the tool opening. (Picture 22, 23, 24)

The bolt manufactured by us after the heat treatment have significantly higher tensile parameters than the parameters of the steel bolts. In addition, it is characterized by high tightening torque (M6 15.5 Nm), and extremely low weight (M6×22 1.9 g).

During the development of the head we kept in mind the weight loss, therefore, the head consists of five separate radial plates, which connected by a ring-like mantle.

The choice of the number of pages is based on the following thesis:
1. the tool do not tilting in the head
2. the sheet has large enough area to bind the bolt core
3. the probability of the tool turn inside out is be small
4. low weight

Versions:

| | Tool | | Tool turn | |
|---|---|---|---|---|
| Planning version | tilting | Enough area | inside out | Weight |
| 1 central sheet | tool | | turn inside | |
| across | tilting | | out | |
| 2 separate sheets | tool | small area which | turn inside | |
| to ring | tilting | is connected to | out | |
| mantle | | the bolt core | | |
| 3 center-sheets | | small area which | turn inside | heavy |
| | | is connected to | out | weight |
| | | the bolt core | | |
| 3 sheets to ring | | small area which | turn inside | |
| mantle | | is connected to | out | |
| | | the bolt core | | |
| 4 center-sheets | tool | | turn inside | heavy |
| | tilting | | out | weight |
| 4 sheets to ring | tool | | turn inside | |
| mantle | tilting | | out | |
| 5 center sheets | | | | heavy |
| | | | | weight |
| 5sheetstorinmantle- | | | | |
| theperfectsolution | | | | |
| 6 center sheets | tool | | | heavy |
| | tilting | | | weight |
| 6 sheets to ring | tool | | | heavy |
| mantle | tilting | | | weight |

NOTES:
7 sheets or more-at large diameter can be used, and at larger diameter we join odd-numbered sheets

The bolt has a special tool, that we manufacture to tight fit because the bolt made of non-magnetic material. We used a loose fit produced tool to take out it.

Piston and Pin

Based on the above-discussed concept we also produce the piston pin is a special high-strength aluminum alloy in favor of the further weight loss.

To reduce the heat load and the wear of the piston we apply ceramic coating.

Crankcase

As usual, the crankcase is made of aluminum, which has been chosen to be the lightest and tolerate all the load. Because of this, we left the distinct bearings; it has been replaced with a crankcase surface applied coating.

Further weight is saved by the specialized join of the crankcase halves. Our solution is different from the usual used in the vehicle industry because the crankcase are inserted not vertically or horizontally, but in 45° angle to each other. The advantage of this is possible to use a construction where the cylinder head bolts passing through the cylinder block are fixed on the opposite crankcase's thread. Thus, the forces occurred on the crankcase cannot tension apart parts, but they are constrict together. A further advantage is that, due to the angle between the bolts forces sharing shear and tensile stress conditions. This way we can based on lower load parameters when design the bolt. If the bolt is replaced with a tube bolt, becomes applicable our new solution. We take a hole at the bottom of the blind thread, in which oil is introduced from the lubrication system of the engine. That's how we can ensure the lubrication of the camshafts with the oil pass through the bolt. (Picture 25-31)

Lubrication System, Clutch Slave Cylinder

The oil line of the crankcase have been designed to its implementation will be the simplest and the cheapest. Therefore, the main oil line is milled in 45° angled contact surface of the crankcase halves, so after the joining we got a slightly oval, but close circle cross-section of main oil line. (Picture 27, 28, 29, 30)

Leaving the sleeve bearings and the small surface of the bearing cups requires the high oil pressure. It's 8-12 bar.

This high pressure allows supplying other systems, for example the clutch. The cylinder sleeve of the clutch slave cylinder is a nut which fix the clutch basket to the input shaft. The clutch piston is inside this nut-sleeve and it's moved by the oil pressure which comes from the other side of the input shaft. Under the oil pressure the piston is pushed directly the clutch pressure plate. So the moving of the plate causes directly from the piston.

During the designing we created an alternative oil supply system, which do not contains the effective oil pump, because the required quantity of oil is get into by an existing gear pair. One of the gear is at the back side of the crankshaft, the other is on the clutch basket. Its a fix drive with correctly modified tooth profile.

The oil system further weight-saving innovation is the lubrication system of the camshafts. In here, the camshaft bearing got a separate oil line, which come from the crankcase through the bolt of the cylinder head. This requires a special hollow bolt. One side of the bolt is placed in the crankcase, on which there is an oil feeding hole. On the other side we fix the bolt to the cylinder head with a special castellated nut, which let the bolt end opened. The slots provide tighten the nut. Therefore it ensures a very high clamping force with low space requirements. The oil flowing out of that goes directly to the camshaft journals. It is better, because with this solution it has got fewer components and the removed material is replaced by oil, which is lighter than the removed material. So the system will be lighter.

Camshaft Timing

A further advantage of the concept is the camshaft timing between the segments, which works with chain gear. The cam chain is in the middle of the camshafts, so the camshaft stress is lower because the twisting force drive two shorter shafts. (Picture 12, 13, 14)

The formal criterion of the camshaft is application of a hollow shaft with larger diameter instead of the usual, at which the shaft filled by the lubricating oil. For wear reduction a small hole are placed on the base circle, among this hole lubricating oil coat to the surface of the tappet at every turning of the camshaft. (Picture 32, 33)

The moving mass is reduced further, because the upper spring plate and the camshaft are manufactured in alternative materials. As far as our case it has been repeatedly used in high-tensile strength aluminum alloy (AW-7075 T6).

Electronics

Our self-developed system work with control principle, monitor continuously the actual values. Depending on this values the system can change its output signs. Furthermore it can chance the programmed initial values, too. Because the row of processes contain a specially programmed learning algorithm. As a result the controlling process approach optimal values during the controlled device working. Like this it improves its own efficiency.

The electronics is one of the main part of the control. The motherboard is designed for a multi-core processor. The processor run the engine controlling program like an infinite loop which placed in the BIOS and it has no operating system. One of the advantage of this solution is the system make less mistake and if there is common memory for the processors the data which the program calculate with would be directly changeable.

The core that doesn't calculate collect and process the input signs, write them into the common memory and read the result from here. With this solution the system can reach higher calculating performance than a unit with FSB. If there is enough input data for the program our self-developed software calculate the time of injection and ignition fast and accurate and regulate the control.

Our unit process large amount of data and make it in real time because of the precise operation. The most important input sign is the angle of the crankshaft. It has to be read extremely accurate and fast. That's why we develop a unit what unconventionally based on to fix a lot of real signs unlike it's standard to interpolate from a few signs. The point of the solution is the disk at the end of the crankshaft. There are physical marks in every 0.1° on the disk. (The distance of the marks is 0.1-0.2 mm)

The marks are made of ferromagnetic material. It has a special reader unit which consist of ten pieces of tubular needles (like really thin injection needles). We fit the needle tips are parallel with the marks in the fixing block. We twist coil to the outer side of the needles and get Nd magnet composite into the needles. (Evidently we focus to the polarity during manufacturing.) The position of the needles is really important. The length of the reader unit has to be equal to the distance of the N−1 marks on the crankshaft disk. We situate the 10 pieces of needles equidistant. This system works like a caliper with Vernier scale. It signs accurate the tenth of the physical marks displacement.

Because of this solution the system can read a lot of real signs in every turn of the crankshaft. It begins the interpolation after 3 input signs and repeat it after every new input sign with the two last signs from the former calculation. A special algorithm associates with the interpolation, at work it can identify the parameters and dynamics of the engine and save the right maximum values with the input data. And then there are similar environment variables it begins the calculation from these saved values. That's why the more engine works the better work and exacter settings.

The program contains optimum researches which specify certain conditions of the engine. For example: biggest angle of rotation=maximum power, λ value x=perfect combustion of fuel.

Manifold, Exhaust Manifold, Ignition Order

Ensuring the air flow is really important in any race especially those race where the restrictor is required. We developed a special intake manifold system. Its shape and arrangement ensure the air get to the cylinders fast and without any hold-up. The soul of this concept is that there is an ‘8 in 1’ group of tubes which come together before the restrictor. Every tube has a line of sight to the common tube. So the air which coming through the restrictor get to the intake valve without any change in the tube diameter. The length of the tubes are equal. The fusion of the tubes is realized along a circle and they followed each other by the ignition order (right). A special property of this solution is come the air vortex used with the Coriolis force. Naturally on the other hemisphere of the Earth (Australia, Brasil) we order the tubes in opposite way (left). In our case the ignition order is 13546827 because of the smoother run of the eight cylindered construction.

The leaving fume has a really high temperature and it comes cooler away from the cylinder head. We use this effect for further weight loss in our engine. In the exhaust system the parts after the exhaust manifold is made of composite material. We used rowing with ceramics. The inside part is a thin tube with 0.1 mm diameter. It's surrounded by the ceramics composite body. We had to pay attention some property of the resin like heat resistance and enrichment which we solved by using ‘glass balls’. With this solution it can tolerate the occurring heat load long enough.

Gearbox and Differential

For weight loss in the racing car we build the drive train and the engine together. In our case the transmission is under the engine because due to the overhang of the exhaust manifolds there is enough space. It used to be placed at most an oil pan here. With a stronger build of the lower half of the crankcase this section is applicable to authorized the gearbox. So the upper half of the transmission housing and the lower half of the crankcase is a common part. This method economized bolts, mass and space. In addition it reduced manufacturing cost. For further weight loss the gear parts are made of high strength aluminium alloy, typically AW-7075 T6. The differential is made of the same alloy, too. Unconventionally the differential gear is placed at the top of the engine. The differential cage is drived by a hollow shaft and we get the halfshaft through this hollow shaft.

1. The concept of the engine, which is a special arrangement, is set to be very different from the usual components of the built-in material selection, differing in the crankcase are inserted non-parallel. The cylinder-head bolt pass throught more parts. This solution constrict the crankcase-parts together. The meaning of the special geometry is the boxer crankshaft installation to a 180° V-engine.

2. The engine is designed by special geometry of connecting rod, characterized in that horizontal section of two back to Back U-shaped profile in reverse direction, which are connected to the central panel. (Picture 15-21).

3. Compact bolt, characterized in that at tightening or opening the bolt forces acting perpendicular to the radius of the head. So eliminating the harmful forces that cause opening of the bolt head, thereby at tightening distorting flexible the torsion torque is transmitted. The head consists of five separate radial plates, which connected by a ring-like mantle.

4. The camshaft is characterized in with the larger diameter. There is an oil hole on the base circle. Among this hole lubricating oil coat to the surface of the tappet.

5. The special plate of the spring is characterized in that it is made of low density, high strength material.

6. Special clutch slave cylinder characterized in the cylinder sleeve of the clutch slave cylinder is a nut which fix the clutch basket to the input shaft. The clutch piston is inside this nut-sleeve and it's moved by the oil pressure which comes from the other side of the input shaft. Under the oil pressure the piston is pushed directly the clutch pressure plate. So the moving of the plate causes directly from the piston.

7. An oil supply system, characterized in that the required quantity of oil is get into by an existing gear pair, with correctly modified tooth profile. For example one of the gear is at the back side of the crankshaft, the other is on the clutch basket.

8. The engine control unit, characterized in that the unit process large amount of data and make it in real time. There are physical marks in every 0.1° on the disk, which is at the end of the crankshaft. (The distance of the marks is 0.1-0.2 mm) The marks are made of ferromagnetic material. It has a special reader unit which consist of ten pieces of tubular needles (like really thin injection needles). We fit the needle tips are parallel with the marks in the fixing block. We twist coil to the outer side of the needles and get Nd magnet composite into the needles. (Evidently we focus to the polarity during manufacturing.) The position of the needles is really important. The length of the reader unit has to be equal to the distance of the N−1 marks on the crankshaft disk. We situate the 10 pieces of needles equidistant. This system works like a caliper with Vernier scale. It signs accurate the tenth of the physical marks displacement.
Because of this solution the system can read a lot of real signs in every turn of the crankshaft. It begins the interpolation after 3 input signs and repeat it after every new input sign with the two last signs from the former calculation. A special algorithm associates with the interpolation, at work it can identify the parameters and dynamics of the engine and save the right maximum values with the input data. And then there are similar environment variables it begins the calculation from these saved values. That's why the more engine works the better work and exacter settings.
The program contains optimum researches which specify certain conditions of the engine. For example: biggest angle of rotation=maximum power, λ value x=perfect combustion of fuel. The electronics is one of the main part of the control. The motherboard is designed for a multi-core processor. The processor run the engine controlling program like an infinite loop which placed in the BIOS and it has no operating system.
The core that doesn't calculate collect and process the input signs, write them into the common memory and read the result from here. With this solution the system can reach higher calculating performance than a unit with FSB. If there is enough input data for the program our self-developed software calculate the time of injection and ignition fast and accurate and regulate the control.

9. Special intake manifold characterized in there is an ‘n in 1’ group of tubes which come together before the restrictor. Every tube has a line of sight to the common tube. So the air which coming through the restrictor get to the intake valve without any change in the tube diameter. The length of the tubes are equal. The fusion of the tubes is realized along a circle and they followed each other by the ignition order (right). A special property of this solution is come the air vortex used with the Coriolis force. Naturally on the other hemisphere of the Earth (Australia, Brasil) we order the tubes in opposite way (left).
